(19) United States
(12) Patent Application Publication
(10) Pub. No.: US 2009/0079155 A1
(43) Pub. Date: Mar. 26, 2009

(54) Pneumatic Shock Absorbing System For a Motor Vehicle

(75) Inventors: Gunter Rehra, Wedemark (DE); Alexander Stiller, Garbsen (DE); Jorg Grotendorst, Nurnberg (DE); Dirk-Heinrich Rabe, Neustadt (DE)

Correspondence Address: MAURICE CHEVALIER, 846 AZA LEA ST., HOUSTON, TX, 77018, US

(73) Assignee: Continental Akiengesellscaft

(21) Appl. No.: 11/922,371

(22) PCT Filed: Jun. 6, 2006
(86) PCT No.: PCT/EP2006/005351

§ 371 Date: Dec. 17, 2007

(30) Foreign Application Priority Data
Jul. 1, 2005 (DE) 10 2005 030 726.4

(51) Int. Cl. B60G 17/052

(52) U.S. Cl. 280/124.16

(57) ABSTRACT

Disclosed is a pneumatic shock absorbing system (1) for a motor vehicle, comprising at least one pneumatic spring (18a, 18b, 18c, 18d) per motor vehicle wheel on at least one vehicle axle, at least one control device (36), at least one compressor (2), at least one pressure sensor (10), at least one on-off valve (20a, 20b, 20c, 20d), and at least one connecting pipe (8, 16a, 16b, 16c, 16d, 62, 64) which is connected to an external source (76) of compressed air. The control device (36) of the pneumatic shock absorbing system (1) receives a start signal for basic filling while at least one valve (20a, 20b, 20c, 20d) is triggered by the control device (36) in such a way that at least one component (8, 16a, 16b, 16c, 16d, 18a, 18b, 18c, 18d, 62, 64) of the pneumatic shock absorbing system (1) is basically filled.

### BACKGROUND OF THE INVENTION

The invention relates to a pneumatic shock absorbing system for a motor vehicle, having at least one air spring per motor vehicle wheel on at least one vehicle axle, at least one control unit, at least one compressor, at least one pressure sensor, at least one on-off valve and at least one connecting line.

Such a pneumatic shock absorbing system is known from DE10055108A1. The pneumatic shock absorbing system which is illustrated is based on a partially closed or closed compressed air system, i.e. the air from the air springs which is no longer required is pumped into a pressure accumulator by the compressor. Likewise, in order to increase the ride level of the vehicle body with respect to at least one vehicle axle, compressed air can be transferred from the pressure accumulator into the air springs. The entire system, that is to say air springs, pressure accumulator, lines, valves and compressors are filled in advance with compressed air. The filling in advance takes place in a new vehicle in the assembly works using an extraneous compressed air source, the filling in advance and actuation of the valves being carried out by an external electric controller. In the case of a service or a repair, the filling in advance may possibly also be carried out by the vehicle's own compressor.

The present invention is based on the object of providing a pneumatic shock absorbing system which can be filled in advance with low expenditure on equipment.

### SUMMARY OF THE INVENTION

For this purpose, the connecting line is connected to an external compressed air source, the control unit of the pneumatic shock absorbing system receives a start signal for the basic filling operation, and at least one valve is actuated by the control unit in such a way that a basic filling operation of the pneumatic shock absorbing system takes place. The advantage is the fact that the basic filling operation of the pneumatic shock absorbing system by an external compressed air source does not require any separate external control device, which reduces costs and significantly simplifies the design of the external filling device. Furthermore, a basic filling operation of the pneumatic shock absorbing system in the case of a repair is possible even in relatively small workshops which are not specialized in, or appropriately equipped for, the repair of pneumatic shock absorbing systems.

The pneumatic shock absorbing system has, as is known, at least two air springs which provide suspension for, and/or damp, the vehicle body relative to the wheel carriers of a vehicle axle. Basic or initial filling of this open, semi-open or closed pneumatic shock absorbing system is necessary after the system is first installed or in the case of a repair if, for example, an air spring or a connecting line has been replaced. In this case, an external compressed air source is connected to a port of the connecting line of the pneumatic shock absorbing system. The control unit receives a signal for starting the basic filling operation of the pneumatic shock absorbing system with the compressed air from the external compressed air source. The start signal can be triggered by a switching device, to be actuated by an external operator, in the interior of the vehicle or by an external switch or the like, to be actuated by an external operator, or by the connection of the external compressed air source to the filling port of the pneumatic shock absorbing system itself.

The valves of the pneumatic shock absorbing system are switched by the control unit for the filling process of the basic filling operation in such a way that all the air springs and possibly the pressure accumulator are filled with a predefined pressure. If the desired pressure is present in all the components (air springs, pressure accumulator, connecting lines, air dryers, etc.) of the pneumatic shock absorbing system, the filling process of the basic filling operation of the pneumatic shock absorbing system is terminated by the control unit of the pneumatic shock absorbing system. The desired filling pressure or setpoint pressure of the pneumatic shock absorbing system is dimensioned such that at least the lowest possible vehicle ride level or the normal vehicle ride level or else all the possible vehicle ride levels, in particular the highest vehicle ride level, can be adjusted by the pneumatic shock absorbing system after the basic filling operation.

According to one development of the invention, there is provision for the pressure in the pneumatic shock absorbing system during the basic filling operation to be monitored using a model. The advantage of the development is the fact that pressure does not have to be monitored continuously during the filling process. For example, the filling time in which a predefined pressure is established in the pneumatic shock absorbing system can be determined from knowledge of the, if appropriate, measured output pressure of the external pressure source and the assumption that this pressure remains constant, as well as the known volumes of the components of the pneumatic shock absorbing system (air springs, pressure accumulator, connecting lines, air dryers, etc.). Alternatively, a filling cycle with specific filling times and filling pauses can be set in order to reach the predefined pressure. Under certain circumstances, the filling model can be used to carry out the basic filling operation more quickly and with fewer switching processes of the valves than if the pressure is measured in each case individually in the corresponding components of the pneumatic shock absorbing system by means of a pressure sensor of the pneumatic shock absorbing system.

According to one development of the invention, there is provision for the pressure in the pneumatic shock absorbing system to be monitored iteratively using a pressure sensor during the basic filling operation. The advantage of the development is that the basic filling operation of the pneumatic shock absorbing system to the predefined pressure takes place very precisely and therefore there is no need for refilling of the pneumatic shock absorbing system within a short time as a result of the operation of the compressor. In order to measure the pressure in the individual components of the pneumatic shock absorbing system, the valves of the pneumatic shock absorbing system are correspondingly switched by the control unit. This can be carried out continuously or at specific time intervals. In all cases, the pressure in at least one component of the pneumatic shock absorbing system is always determined only for a specific time and with specific chronological interruptions, that is to say iteratively. During the chronological interruption, the pressure in another component of the pneumatic shock absorbing system can be determined, etc.

According to one development of the invention, there is provision for at least one pressure accumulator to be provided which, during the basic filling operation, can be filled with compressed air from the external compressed air source. The advantage here is that not only are the air springs and connecting lines filled (in advance) with the pressure, but also the pressure accumulator which is present, if appropriate, is filled (in advance). The pneumatic shock absorbing system is thus immediately functionally capable after the basic filling process or initial filling process so that all the significant ride level control functions can be carried out.

According to one development of the invention, there is provision for first of all the pressure accumulator to be filled with compressed air up to a predefinable pressure, then for the air springs to be filled with compressed air up to the desired air spring filling pressure, and subsequently for the pressure accumulator to be filled with compressed air up to the pressure accumulator filling pressure. The advantage of this development is that improved pressure equalization takes place in the entire pneumatic shock absorbing system, and said pressure equalization reduces the influence of the air flow due to the filling process and the resulting pressure gradient so that the pressure in the pressure accumulator and/or the other components of the pneumatic shock absorbing system such as, for example, air springs, connecting line, compressor with air dryer, valves, etc., can be determined more precisely after the interruption of the filling process and corresponding pressure equalization as well as without influencing the air flow due to the filling process.

According to one development of the invention, there is provision for the compressor to be able to be operated with compressed air from the external compressed air source in order to assist the basic filling operation of the pneumatic shock absorbing system. An advantage of the development is that the filling process can be carried out more quickly. A further advantage is that the filling process can be carried out just up to the desired setpoint pressure if the pressure of the external pressure source is less than or equal to the setpoint filling pressure. Furthermore, it is possible for individual components of the pneumatic shock absorbing system such as, for example, the pressure accumulator or individual air springs, to be filled with a higher pressure than the pressure of the external pressure source.

According to one development of the invention, there is provision for the basic filling operation of the pneumatic shock absorbing system to be ended if the pressure in the individual chambers corresponds to the respective setpoint pressure. The advantage of this development is that the pneumatic shock absorbing system is filled with precisely the required pressure or the required quantity of air so that the pneumatic shock absorbing system is functionally capable to the greatest possible extent.

According to one development of the invention, there is provision that all the ride level control functions of the pneumatic shock absorbing system can be enabled after the basic filling operation has taken place. The advantage of the development is that the pressure or the quantity of air in the pneumatic shock absorbing system after the filling process corresponds to the optimum pressure or the optimum quantity of air so that all the ride level control functions can be carried out in a practical way and can be enabled as they are required.

According to one development of the invention, there is provision for the control unit to output a termination signal after the basic filling operation of the pneumatic shock absorbing system has taken place. An advantage is that the end of the successful basic filling operation can be indicated to the operating personnel visually or audibly by means of the termination signal. Furthermore, it is thus possible for the termination signal to trigger processes in external systems, for example for automatic decoupling of the connecting point of the pneumatic shock absorbing system from the external pressure source to be performed.

According to one development of the invention, there is provision for the termination signal of the control unit of the pneumatic shock absorbing system to be evaluated by further vehicle systems in such a way that their functional capability can be matched to the functional capability of the pneumatic shock absorbing system. The advantage of this development is that predetermined functions of the further vehicle systems can be carried out only after the end of the basic filling operation of the pneumatic shock absorbing system. For example, the maximum travel speed of the vehicle can be limited to “walking pace” before the basic filling operation and a relatively high limiting value for the travel speed can be defined per type of vehicle after the basic filling operation has taken place. However, alternatively the values for the braking intervention of an ABS or ESP system are modified after the basic filling operation has taken place.

According to one development of the invention, there is provision for the pneumatic shock absorbing system to be embodied with an open, semi-open or closed pneumatic circuit. The advantage of the development is that each pneumatic shock absorbing system is to be equipped with simple means in such a way that the control unit of said means performs open-loop and/or closed-loop control on a corresponding basic filling operation.

According to one development of the invention, there is provision for an air dryer to be arranged between the connecting line of the pneumatic shock absorbing system and the external pressure source. The advantage of this development is that the compressed air which is filled into the pneumatic shock absorbing system by the external pressure source is additionally dried, and the humidity of the air in the pneumatic shock absorbing system therefore remains as low as possible from the beginning. In this way, after a reduction in the temperature of the ambient air the risk of subsequent icing up of valves, connecting lines or the like while the vehicle and the pneumatic shock absorbing system are operating can be reduced significantly.

According to one development of the invention, there is provision for the air dryer to be dimensioned in such a way that a pressure dew point of the compressed air in the pneumatic shock absorbing system of at least 20 kelvin with respect to the ambient temperature can be reached at the end of the basic filling operation. This development ensures that during or after the vehicle has been put into operation in most countries with “normal” humidity of the air and moderate average temperatures, no icing up of the pneumatic shock absorbing system can occur.

According to one development of the invention, there is provision for the pressure dew point of the compressed air in the pneumatic shock absorbing system to be at least 40 kelvin with respect to the ambient temperature at the end of the basic filling operation. This development ensures that during or after the vehicle has been put into operation in virtually all countries, no icing up of the pneumatic shock absorbing system can occur since the corresponding reduction in the dew point of the compressed air is sufficiently large at more than 40 kelvin.

According to one development of the invention, there is provision for the humidity of the compressed air which is passed through the air dryer between the connecting line of the pneumatic shock absorbing system and the external pressure source into the pneumatic shock absorbing system to be monitored by the control unit of the pneumatic shock absorbing system. The advantage of this development is that the humidity of the air in the pneumatic shock absorbing system during and/or after the basic filling operation is known. As a result, the regeneration intervals of the pneumatic shock absorbing system can be matched to the humidity of the air of the pneumatic shock absorbing system after the basic filling operation, and can be correspondingly shortened or prolonged.

According to one development of the invention, there is provision for the filling process of the pneumatic shock absorbing system to be interrupted if the humidity of the compressed air in the pneumatic shock absorbing system exceeds a limiting value. The advantage is that the humidity of the air in the pneumatic shock absorbing system is monitored and the filling process is interrupted or aborted under certain conditions which can adversely affect the pneumatic shock absorbing system. As a result, the humidity of the air in the pneumatic shock absorbing system after a basic filling operation always corresponds at least to a predetermined limiting value for the humidity of the air which is required for satisfactory operation of the pneumatic shock absorbing system.

According to one development of the invention, there is provision for the control unit of the pneumatic shock absorbing system to initiate a regeneration operating mode of the air dryer between the connecting line of the pneumatic shock absorbing system and the external pressure source. The advantage of the development is that the air dryer can be regenerated without having to be replaced so that no additional expenditure on installation for refitting the external pressure source and/or the air dryer is necessary.

According to one development of the invention, there is provision for the control unit of the pneumatic shock absorbing system to continue the interrupted filling process of the pneumatic shock absorbing system if the regeneration of the air dryer between the connecting line of the pneumatic shock absorbing system and the external pressure source is terminated. The advantage of the development is that the air dryer can be regenerated and the basic filling process can be continued and, if appropriate, terminated without entailing additional expenditure on installation for refitting the external pressure source and/or the air dryer. Furthermore, the predetermined limiting value for the humidity of the air in the pneumatic shock absorbing system is not exceeded during or after the basic filling process.

According to one development of the invention, there is provision for a pneumatic shock absorbing system as claimed in one of the preceding claims to be used. The advantage of this development is that almost all the necessary method steps are initiated and monitored by the control unit so that the open-loop and/or closed-loop control of the basic filling operation can be carried out, as it were, autonomously by the control unit of the pneumatic shock absorbing system. Only the connection of the external pressure source and/or of the external air dryer to the external connecting line of the pneumatic shock absorbing system and, if appropriate, the triggering of the start signal for the basic filling process require “external” process sequences.

An exemplary embodiment and further advantages of the invention are explained in conjunction with the figures below.

### BRIEF DESCRIPTION OF THE DRAWINGS

In the drawings,

FIG. 1 shows an open ride level control system, and

FIG. 2 shows a closed ride level control system.

### DETAILED DESCRIPTION OF THE DRAWINGS

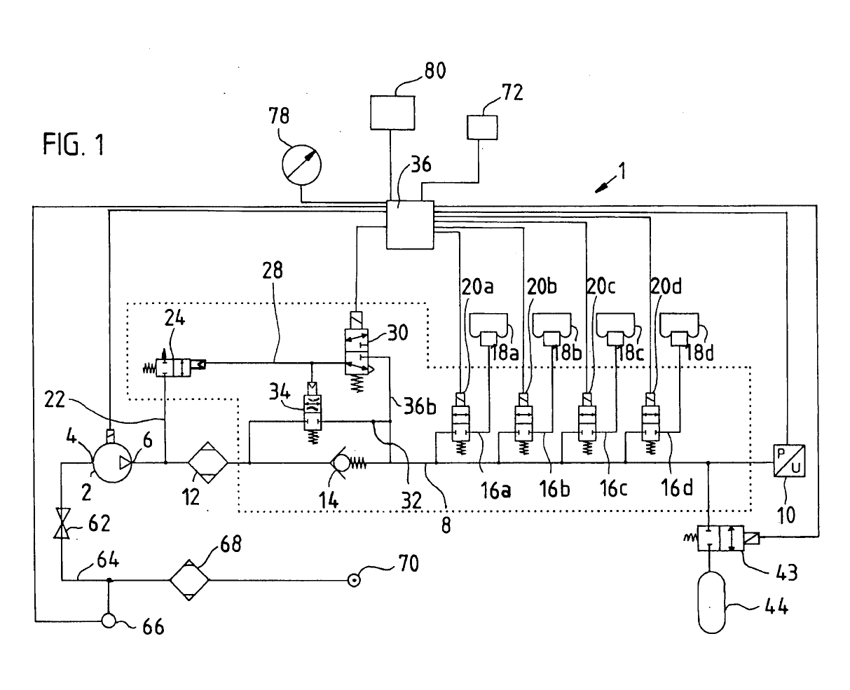

FIG. 1 shows an open ride level control system with a compressor 2 which has an inlet 4 and an outlet 6. The sensor compressed air line 8, which ends at a compressed air sensor 10, starts at the outlet 6. An air dryer 12 and a nonreturn valve 14, which opens in the direction of the pressure sensor 10, are located in the sensor compressed air line 8. The sensor compressed air line 8 is embodied as a main line from which compressed air lines 16a to 16d branch off and end in air springs 18a to 18d. Switchable directional control valves 20a to 20d are located in the compressed air lines 16a to 16d and in their first switched state they block the respective compressed air line 16a to 16d and in their second switched state they connect through the respective compressed air line 16a to 16d.

Between the outlet 6 of the compressor 2 and the air dryer 12, a discharge line 22 branches off from the sensor compressed air line 8 and ends in a switchable directional control valve 24. In a first switched state the switchable directional control valve 24 blocks the discharge line, and in a second switched state it connects said discharge line to the atmosphere. The switchable directional control valve 24 is embodied as a pneumatic directional control valve, and the pneumatic control inlet 26 is actuated by means of the compressed air line 28 in which a switchable directional control valve 30 is located. The nonreturn valve 14 is bypassed by a compressed air line 32 in which a pneumatically switchable directional control valve 34 is also located. The electrically switchable directional control valves 20a to 20d and 30 are controlled by the control unit 36 of the ride level control system. In addition, the control unit 36 controls the compressor 2.

A compressed air line branches off to a pressure accumulator 44 from the sensor compressed air line 8. Said compressed air line is blocked by a magnetic directional control valve 43 in a first state and connected through in a second state so that compressed air can be transferred from the compressed air line 8 into the pressure accumulator 44, or vice versa. The compressed air in the compressed air line 8 can be directed to the air springs 18a to 18d or into the atmosphere, or is transferred into the compressed air line 8 from the compressor outlet 6 or the air springs 18a to 18d. Using the ride level control system shown in FIG. 1, each individual air spring 18a to 18d can be filled with compressed air in order to raise the ride level, or discharged into the atmosphere in order to lower the ride level. EP 0 978 397 B1 describes in detail how this takes place in particular so that more details on it will not be given here.

An intake compressed air line 64 branches off from the inlet 4 of the compressor 2 and has an external port 62 in order to be able to connect an air filter or sound damper (not illustrated) or an external compressed air source 76. The compressed air line 64 is to be configured in accordance with the applied pressure level, for example the maximum pressure level of the external pressure source 76, so that leaks do not arise. Between the external port 62 and the external pressure source 76 a further air dryer 68 is arranged, said air dryer 68 drying the compressed air which transfers into the pneumatic shock absorbing system 1 from the external pressure source 76.

The air dryer 68 is ideally configured in such a way that the humidity of the compressed air which is transferred into the pneumatic shock absorbing system 1 has been dried to such an extent that an adverse functional effect due to precipitated water, in particular icing up, of the valves and/or compressed air lines cannot occur in any application situation of the pneumatic shock absorbing system 1. Depending on the field of application and customary ambient temperatures, it is sufficient to lower the pressure dew point by 40 kelvin compared to the current ambient temperature during the filling process. In a number of geographical regions with relatively constant ambient temperatures, it is generally sufficient to lower the pressure dew point of the compressed air in the pneumatic shock absorbing system 1 by 20 kelvin compared to the current ambient temperature during the filling process or after the filling process. Of course, intermediate values or any other desired reduction of the pressure dew point can also be considered and set.

The air dryer 68 is preferably configured in such a way that the drying capacity of the air dryer 68 permits a complete filling process of the pneumatic shock absorbing system 1 by the external pressure source 76 while maintaining the required reduction in the pressure dew point without permitting an interruption or the like. For this purpose, the size (length and diameter) of the air dryer 68 in conjunction with the drying medium used (molecular sieve, aluminum oxide, silica oxide, diaphragms, etc.) is matched to the filling volume and the filling pressure of the pneumatic shock absorbing system 1 as a function of the pressure and the pressure dew point of the external pressure source 76. However, since the pressure dew point of the compressed air of the external pressure source 76 is not always known and the pressure level of the external pressure source 76 can vary greatly, it is appropriate to monitor the air quality, i.e. at least the pressure dew point of the compressed air which is transferred into the pneumatic shock absorbing system 1 from the external air dryer 68, and if appropriate to regenerate and/or replace the air dryer 68 if a limiting value of the air quality is exceeded.

In the example shown in FIG. 1, a sensor 66 is arranged between the further external air dryer 68 and the external compressed air port 62, said sensor 66 monitoring the pressure dew point of the compressed air which is transferred into the pneumatic shock absorbing system 1 from the external pressure source 76. The sensor 66 can ideally monitor the humidity of the air, the air temperature and the pressure of the compressed air in the compressed air line 64. It is also possible to arrange the sensor 66 directly in the air dryer 68. The sensor 66 is connected via a signal line to the control unit 36 of the pneumatic shock absorbing system 1 so that the signals from the sensor 66 can be evaluated and monitored by the control unit 36. If, therefore, a limiting value of the air quality of the compressed air in the compressed air line 64 is exceeded, the control unit 36 receives a corresponding signal and can interrupt or abort the filling process of the pneumatic shock absorbing system 1 by means of the external pressure source 76, in order to regenerate the external air dryer 68 or replace the external air dryer 68.

In order to regenerate the external air dryer 68, a switchable directional control valve 72, which is arranged in a compressed air line which branches off from the compressed air line 64 between the air dryer 68 and the external pressure source 76, is actuated by the control unit 36 in such a way that it is transferred from a first closed switched state into a second opened switched state. In the second switched state of the directional control valve 72, the compressed air line 64 is connected via the line 70 to a line 74 leading to the atmosphere so that at least some of the compressed air from the pneumatic shock absorbing system 1 can be transferred into the atmosphere via the external port 62 through the compressed air line 64 and the external air dryer 68, in order to regenerate the air dryer 68. In order to increase the effectiveness of the regeneration of the external air dryer 68, an arrangement (known per se and not illustrated) composed of a throttle and a nonreturn valve is provided in the air dryer 68 so that the compressed air of the pneumatic shock absorbing system 1 can be relaxed as far as possible before it enters the dryer bed of the air dryer 68 and into the atmosphere line 74. So that no compressed air escapes into the atmosphere from the external pressure source 76 during the regeneration of the air dryer 68, a further switchable directional control valve (not illustrated) can be arranged between the external pressure source 76 and the connecting point of the compressed air lines 64 and 70, which switchable directional control valve is also connected to the control unit 36 of the pneumatic shock absorbing system 1 and is correspondingly actuated, i.e. opened and closed, by it.

In order to fill the individual components 18a to 18d, 44 of the pneumatic shock absorbing system 1 with compressed air from the external pressure source 76, the valves 20a to 20d and/or 43 are correspondingly actuated by the control unit 36. The compressed air of the external pressure source 76 is conducted as far as the inlet 4 of the compressor 2 via the compressed air line 64, the external air dryer 68 and the external port 62, and is transferred from there, as described above, into the individual components 18a to 18d, 44, with or without the assistance of the compressor 2 or compressor operation. The pressure in the individual components 18a to 18d, 44 can be determined with the pressure sensor 10, as described above. If appropriate, a further switchable directional control valve which is connected to the control unit 36 can be arranged in the external port 62 in order to open or close the compressed air line 64 to the compressor inlet 4 and thus start or end/interrupt the filling process.

If the necessary filling pressure or a limiting value for the pressure in a component 18a to 18d, 44 is reached, the corresponding valve 20a to 20d and/or 43 is closed. If the necessary filling pressure in all the components 18a to 18d, 44 is reached, the filling process of the basic filling operation is terminated and the control unit 36 sends a termination signal to an audible or visual display unit 78 so that the compressed air line 64 can be disconnected from the external port 62. Disconnection of the compressed air line 64 from the external port 62 can be carried out either by operating personnel or automatically by a robot or the like. The termination signal of the basic filling operation which signals the termination of the successful basic filling operation of the pneumatic shock absorbing system 1 is made available to at least one further vehicle system 80 via a connecting line.

After the successful basic filling operation of the pneumatic shock absorbing system 1, it is possible to carry out specific system functions, which it was previously not possible to carry out, both in the further vehicle system 80 and in the pneumatic shock absorbing system 1 itself. This can relate, in the case of the pneumatic shock absorbing system 1 to, for example, closed-loop control to a high ride level or the maximum ride level or the inflation of a spare wheel. In a further vehicle system 80, the functional capability of the ABS, traction control or ESP system or that of the steering system can be matched to the functional capability of the pneumatic shock absorbing system 1, and thus extended after the basic filling operation has taken place. This is appropriate since the corresponding control values are influenced, for example, by the vehicle ride level.

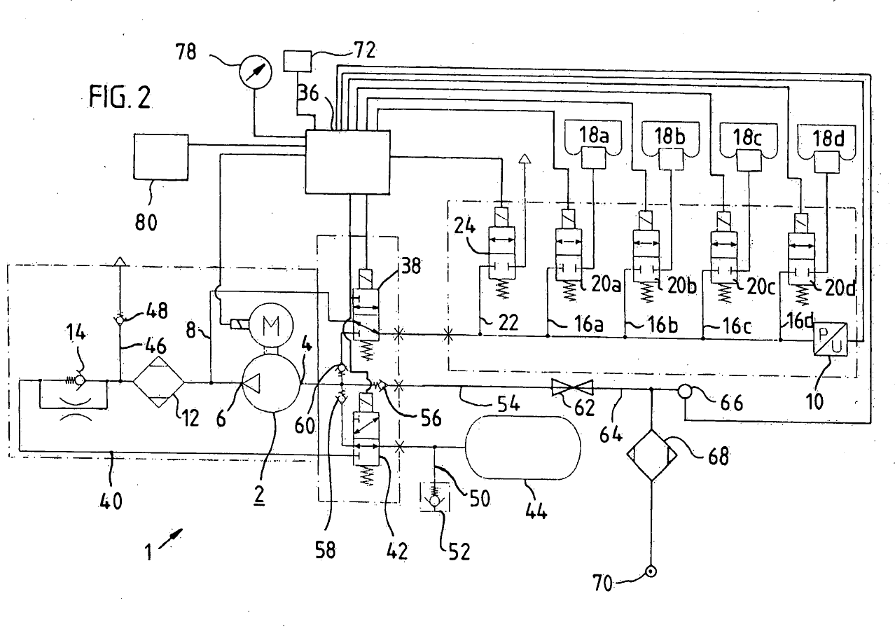

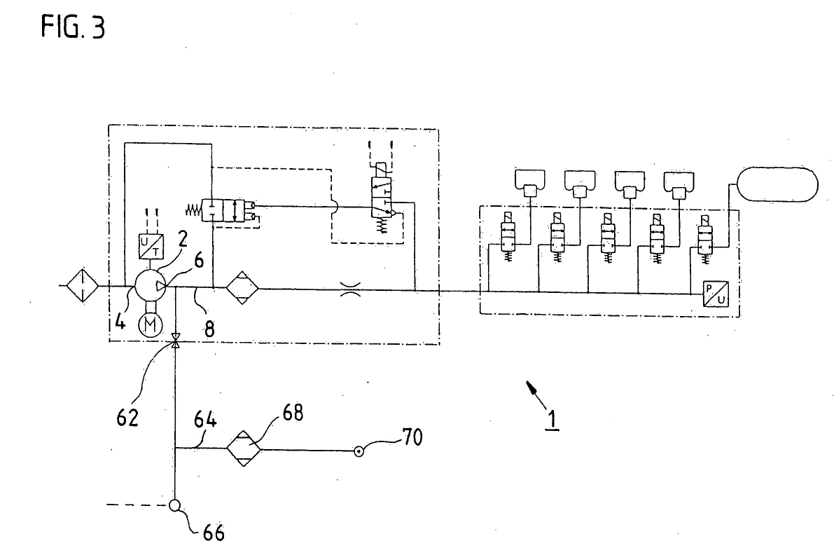

FIG. 2 shows a closed ride level control system whose design is known per se from the prior art and is described in detail in EP 1 243 447 A2. For this reason, the design of the ride level control system will be described at this point only to the extent that is necessary for the following explanations. The ride level control system contains a compressor 2 with an inlet 4 and an outlet 6. A plurality of compressed air lines are connected to the outlet 6 of the compressor 2. As a result, the sensor compressed air line 8 starts from the outlet 6 and ends in the pressure sensor 10. The sensor compressed air line 8 is embodied, in precisely the same way as the ride level control system shown in FIG. 1, as a main line from which compressed air lines 16a to 16d branch off to air springs 18a to 18d in which switchable directional control valves 20a to 20d are located.

In addition, the discharge line 22, in which a switchable directional control valve 24 is located, branches off from the sensor compressed air line 8. In addition to the sensor compressed air line 8, the compressed air lines 16a to 16d and the discharge line 22, the compressed air line 40 branches off from the outlet 6 of the compressor 2 and it can be connected to the compressed air accumulator 44 of the closed ride level control system via a switchable directional control valve 42. A further compressed air line 46, in which an overpressure valve 48 in the form of a nonreturn valve is located, branches off from the compressed air line 40. When there is an extreme overpressure in the ride level control system, the compressor 2 can feed directly into the atmosphere via the compressed air line 46 so that it is not damaged. In addition, a compressed air line 50, in which a nonreturn valve 52 which opens in the direction of the compressed air line 40 is located, branches off from the compressed air line 40 between the switchable directional control valve 42 and the compressed air accumulator 44. An external compressed air source, via which initial filling of the compressed air accumulator 44 can take place in order to protect the compressor 2, can be connected to the compressed air line 50. In addition, the inlet 4 of the compressor 2 is connected directly to the atmosphere via a compressed air line 54. A nonreturn valve 56, which opens in the direction of the inlet 4 of the compressor, is located in the compressed air line 54. The air springs 18a to 18d can be filled via the compressed air line 54 using the compressor 2 if no compressed air, or too little compressed air, is present in the compressed air accumulator 44. In this case, the nonreturn valve 56 opens and the nonreturn valve 58 is automatically blocked so that the compressor 2 sucks in compressed air directly from the atmosphere.

A basic filling process takes place using the pneumatic shock absorbing system shown in FIG. 2, analogously to the description of the pneumatic shock absorbing system in FIG. 1. The atmosphere line 54 is connected via an external port 62 to a compressed air line 64 which leads to an external pressure source 76. An external air dryer 68 is arranged between the external pressure source 76 and the external port 62. In order, as described above, to regenerate the air dryer, a compressed air line 70 branches off between the external air dryer 68 and the external pressure source 76 and can be connected to the atmosphere line 74, or disconnected from it, by means of a switchable directional control valve 72. The sequence of the filling process of the pneumatic shock absorbing system 1 by means of the external pressure source 76 or the regeneration of the external air dryer 68 proceeds with the corresponding particularities of the exemplary embodiment according to FIG. 2 in terms of circuitry, but otherwise is as described with respect to FIG. 1. Likewise, the acoustic or visual display of the termination signal of the basic filling process in the display unit 78 and the transmission of the termination signal of the basic filling process to at least one further vehicle system 80 by the control unit 36 is carried out as in the description of FIG. 1.

FIG. 3 illustrates by way of example how the external port 62 must not necessarily be connected to the compressor inlet 4 (as illustrated with respect to FIGS. 1 and 2) but rather can also be connected directly to the compressed air line 8. In this exemplary embodiment according to FIG. 3, the compressed air of the external compressed air source (not illustrated here) is not conducted through the compressor 2 during the basic filling process of the pneumatic shock absorbing system, which possibly reduces the flow resistance of the compressed air. However, in this case it is also impossible to operate the compressor 2 in order to assist the filling process. However, otherwise all the functions which are necessary for the basic filling process of the pneumatic shock absorbing system as mentioned in the description of FIGS. 1 and 2 can be carried out.

The inventive basic filling operation of a pneumatic shock absorbing system is not restricted to the aforesaid exemplary embodiments but rather can be carried out with all other known pneumatic shock absorbing systems which are equipped with the corresponding components, in which case small adaptations may possibly be necessary.

### LIST OF REFERENCE NUMERALS

(part of the description)
1 Pneumatic shock absorbing system
Compressor
4 Inlet
6 Outlet
8 Sensor compressed air line
10 Pressure sensor
12 Air dryer
14 Nonreturn valve
16a-16d Compressed air line
18a-18d Air springs
20a-20d Switchable directional control valve
22 Discharge line
24 Switchable directional control valve
26 Pneumatic control inlet
28 Compressed air line
30 Switchable directional control valve
32 Compressed air line
34 Switchable directional control valve
36 Control unit
38 Switchable directional control valve
40 Compressed air line
42 Switchable directional control valve
43 Switchable directional control valve
44 Pressure accumulator
46 Compressed air line
48 Nonreturn valve
50 Compressed air line
52 Nonreturn valve
54 Atmosphere line
56, 58, 60 Nonreturn valve
62 Connecting line
64 Compressed air line
66 Sensor
68 (External) air dryer
70 Compressed air line
72 Switchable directional control valve
74 Atmosphere line
76 (External) pressure source
78 Display unit
80 Vehicle system

1-19. (canceled)

20. A pneumatic shock absorbing system (1) for a motor vehicle, having at least one air spring (18a, 18b, 18c, 18d) per motor vehicle wheel on at least one vehicle axle, at least one control unit (36), at least one compressor (2), at least one pressure sensor (10), at least one on-off valve (20a, 20b, 20c, 20d) and at least one connecting line (8, 16a, 16b, 16c, 16d, 62, 64), wherein
the connecting line (8, 64) is connected to an external compressed air source (76), the control unit (36) of the pneumatic shock absorbing system (1) receives a start signal for a basic filling operation,
at least one valve (20a, 20b, 20c, 20d) is actuated by the control unit (36) in such a way that a basic filling operation of at least one component (8, 16a, 16b, 16c, 16d, 18a, 18b, 18c, 18d, 62, 64) of the pneumatic shock absorbing system (1) takes place.

21. The pneumatic shock absorbing system (1) for a motor vehicle as claimed in claim 20, wherein the pressure in the pneumatic shock absorbing system (1) during the basic filling operation is monitored using a model.

22. The pneumatic shock absorbing system (1) for a motor vehicle as claimed in claim 20, wherein the pressure in the pneumatic shock absorbing system (1) is monitored iteratively using a pressure sensor (10) during the basic filling operation.

23. The pneumatic shock absorbing system (1) for a motor vehicle as claimed in claim 20, wherein at least one pressure accumulator (44) is provided which, during the basic filling operation, can be filled with compressed air from the external compressed air source (76).

24. The pneumatic shock absorbing system (1) for a motor vehicle as claimed in claim 23, wherein
the system first fills the pressure accumulator (44) with compressed air up to a predefinable pressure,
then the system fills the air springs (18a, 18b, 18c, 18d) with compressed air up to the desired air spring filling pressure, and subsequently the system fills the pressure accumulator (44) with compressed air up to the pressure accumulator filling pressure.

25. The pneumatic shock absorbing system (1) for a motor vehicle as claimed in claim 20, wherein the compressor (2) can be operated with compressed air from the external compressed air source (76) in order to assist the basic filling operation of the pneumatic shock absorbing system (1).

26. The pneumatic shock absorbing system (1) for a motor vehicle as claimed in claim 20, wherein the basic filling operation of the pneumatic shock absorbing system (1) is ended if the pressure in the individual components (8, 12, 18a, 18b, 18c, 18d, 44) corresponds to respective setpoint pressure values.

27. The pneumatic shock absorbing system (1) for a motor vehicle as claimed in claim 20, wherein all ride level control functions of the pneumatic shock absorbing system (1) can be enabled after the basic filling operation has taken place.

28. The pneumatic shock absorbing system (1) for a motor vehicle as claimed in claim 20, wherein the control unit (36) outputs a termination signal after the basic filling operation of the pneumatic shock absorbing system (1) has taken place.

29. The pneumatic shock absorbing system (1) for a motor vehicle as claimed in claim 28, wherein the termination signal of the control unit (36) of the pneumatic shock absorbing system (1) is evaluated by further vehicle systems (80) in such a way that their functional capability can be matched to the functional capability of the pneumatic shock absorbing system (1).

30. The pneumatic shock absorbing system (1) for a motor vehicle as claimed in claim 20, wherein an air dryer (68) is arranged between the connecting line (8, 62, 64) of the pneumatic shock absorbing system (1) and the external compressed air source (76).

31. The pneumatic shock absorbing system (1) for a motor vehicle as claimed in claim 30, wherein the air dryer (68) is dimensioned in such a way that a pressure dew point of the compressed air in the pneumatic shock absorbing system (1) of at least 20 kelvin with respect to the ambient temperature can be reached at the end of the basic filling operation.

32. The pneumatic shock absorbing system (1) for a motor vehicle as claimed in claim 31, wherein the pressure dew point of the compressed air in the pneumatic shock absorbing system (1) is at least 40 kelvin with respect to the ambient temperature at the end of the basic filling operation.

33. The pneumatic shock absorbing system (1) for a motor vehicle as claimed in claim 30, wherein the humidity of the compressed air which is passed through the air dryer (68) between the connecting line (8, 62, 64) of the pneumatic shock absorbing system and the external pressure source (76) into the pneumatic shock absorbing system (1) is monitored by the control unit (36) of the pneumatic shock absorbing system (1).

34. The pneumatic shock absorbing system (1) for a motor vehicle as claimed in claim 33, wherein the filling process of the pneumatic shock absorbing system (1) is interrupted if the humidity of the compressed air in the pneumatic shock absorbing system (1) exceeds a limiting value.

35. The pneumatic shock absorbing system (1) for a motor vehicle as claimed in claim 34, wherein the control unit (36) of the pneumatic shock absorbing system (1) initiates a regeneration operating mode of the air dryer (68) between the connecting line (8, 62, 64) of the pneumatic shock absorbing system (8) and the external pressure source (76).

36. The pneumatic shock absorbing system (1) for a motor vehicle as claimed in claim 35, wherein the control unit (36) of the pneumatic shock absorbing system (1) continues the interrupted filling process of the pneumatic shock absorbing system (1) if the regeneration of the air dryer (68) between the connecting line (8, 62, 64) of the pneumatic shock absorbing system (1) and the external pressure source (76) is terminated.
